(19) United States
(12) Patent Application Publication
(10) Pub. No.: US 2020/0074914 A1
(43) Pub. Date: Mar. 5, 2020

(54) DISPLAY SYSTEMS AND DISPLAY SYSTEM OPERATION METHODS

(71) Applicant: InnoLux Corporation, Miao-Li County (TW)

(72) Inventors: Yu-Cheng WANG, Miao-Li County (TW); Chia-Ming WU, Miao-Li County (TW); Yi-Cheng CHANG, Miao-Li County (TW)

(21) Appl. No.: 16/546,530

(22) Filed: Aug. 21, 2019

(30) Foreign Application Priority Data
Sep. 4, 2018 (CN) 201811027837.X

(51) Int. Cl. G09G 3/20

(52) U.S. Cl. CPC G09G 3/2092; G09G 2370/042; G09G 2350/00; G09G 2310/08

(57) ABSTRACT

A display system operation method, including outputting a first enable signal and first data corresponding to a working area of a display panel by a transmitting end of an encoder; receiving the first enable signal and the first data by a receiving end of a receiver; generating a second enable signal and second data in accordance with the shape of the working area, the first enable signal and the first data, wherein the second enable signal includes pulse signals of the working area and a non-working area by the decoder; and enabling the display panel to display an image on the screen in accordance with the second enable signal and the second data by a timing controller.

### CROSS REFERENCE TO RELATED APPLICATIONS

This application claims priority of China Patent Application No. 201811027837.X, filed on Sep. 4 2018, the entirety of which is incorporated by reference herein.

### FIELD OF THE PRESENT DISCLOSURE

The present disclosure relates to a display system, a display system operation method, and an electronic device.

### DESCRIPTION OF THE RELATED ART

As displays are used more widely, the display area of a display will soon no longer be limited to the conventional rectangular shape as they are now. However, when the display area of a display has an irregular shape, this irregularly shaped display will include a large non-working area, so to achieve the same resolution, the bandwidth required for an irregularly shaped display to transmit the same image data will be greater than that required for a typical rectangular display. Therefore, how to improve data transmission efficiency of an irregularly shaped display is currently a problem that needs to be solved.

### BRIEF SUMMARY OF THE PRESENT DISCLOSURE

In order to resolve the problem described above, the present disclosure discloses a display system, comprising a transmitting end and a receiving end. The transmitting end includes an encoder. The encoder outputs a first enable signal and first data corresponding to a working area of a display panel. The receiving end includes a decoder and a timing controller. The decoder generates a second enable signal and second data in accordance with the shape of the working area, the first enable signal and the first data. The second enable signal comprises pulse signals of the working area and a non-working area. The timing controller enables the display panel to display an image on the screen in accordance with the second enable signal and the second data.

According to the display system disclosed above, information concerning the shape of the working area is stored in a storage device of the receiving end.

According to the display system disclosed above, the encoder further receives the shape of the working area from the device via a communication protocol after the receiving end is started up.

According to the display system disclosed above, the shape of the working area of the display panel is stored in extended display identification data (EDID).

According to the display system disclosed above, the encoder further divides the working area into a plurality of sub-areas of the same size, and generates the first enable signal and the first data based on the plurality of sub-areas, wherein each of the sub-areas comprises a plurality of pixels.

According to the display system disclosed above, the first enable signal and the first data comprise at least two data corresponding to the same row of pixels in the display panel.

The present disclosure discloses a display system operation method, comprising outputting a first enable signal and first data corresponding to a working area of a display panel by a transmitting end of an encoder; receiving the first enable signal and the first data by a receiving end of a receiver; generating a second enable signal and second data in accordance with the shape of the working area, the first enable signal and the first data, wherein the second enable signal comprises pulse signals of the working area and a non-working area by the decoder; and enabling the display panel, by a timing controller, to display an image on the screen in accordance with the second enable signal and the second data.

The display system operation method further comprises receiving the shape of the working area from a device via a communication protocol by the encoder after the receiving end is started up.

The display system operation method further comprises dividing the working area into a plurality of sub-areas of the same size by the encoder; and generating the first enable signal and the first data based on the plurality of sub-areas by the encoder. Each of the sub-areas comprises a plurality of pixels.

According to the display system operation method, the first enable signal and the first data comprise at least two data corresponding to a same row of pixels in the display panel.

### BRIEF DESCRIPTION OF THE DRAWINGS

FIG. 1 is a system architecture diagram of a display system in accordance with an embodiment of the disclosure.

FIG. 2 is a schematic diagram of a video frame labeled with a working area and a non-working area in accordance with the embodiment of the disclosure.

FIG. 3 is a schematic diagram of a video frame labeled with a working area and a non-working area in accordance with another embodiment of the disclosure.

FIG. 4 is a schematic diagram of a first enable signal corresponding to the working area in FIG. 3.

FIG. 5A is a schematic diagram of pulses corresponding to each of the rows of the first enable signal after encoding by an encoder.

FIG. 5B is a schematic diagram of pulses corresponding to each of the rows of the second enable signal after decoding by the decoder.

FIG. 6 is a schematic diagram of labeled with a non-working area and a working area in accordance with another embodiment of the disclosure.

FIG. 7 is a flow chart of a display system operation method in accordance with an embodiment of the disclosure.

### DETAILED DESCRIPTION OF THE PRESENT DISCLOSURE

The present disclosure can be more fully understood by reading the subsequent detailed description with references made to the accompanying figures.

It should be understood that the figures are not drawn to scale in accordance with standard practice in the industry. In fact, it is allowed to arbitrarily enlarge or reduce the size of devices for clear illustration.

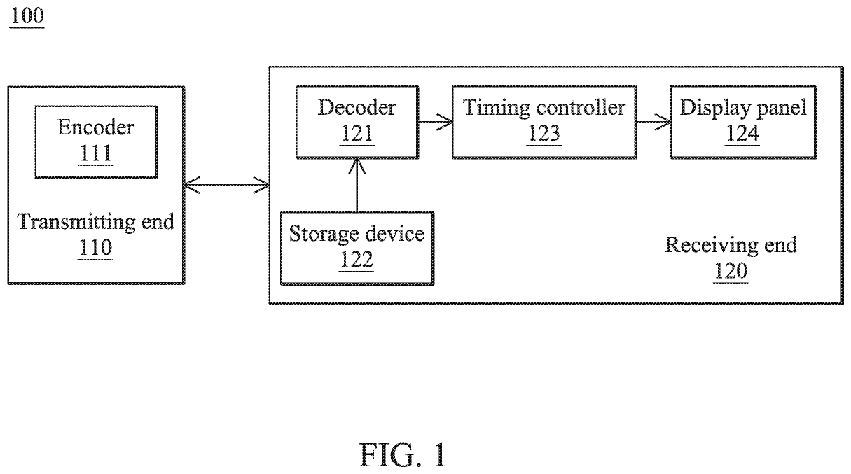

FIG. 1 is a system architecture diagram of a display system in accordance with an embodiment of the disclosure. A display system 100 includes a transmitting end 110 and a receiving end 120. The transmitting end 110 can be an electronic device including at least an encoder 111. The encoder 111 can be implemented in various manners, for example, by using a dedicated hardware circuit or a general purpose hardware (such as a single processor or multiple processers with the capabilities for parallel processing, a graphics processor, or another processer capable of computing) to generate and output an enable signal (a first enable signal) corresponding to a working area (region) in a video frame and first data corresponding to pixel information of the working area to the receiving end 120. The receiving end 120 can be a display including at least a decoder 121, a storage device 122, a timing controller (TCON) 123, and a display panel 124. The decoder 121 generates a second enable signal and second data in accordance with the received first enable signal, the first data and the shape of the working area. The second enable signal may include pulse signals of the working area and a non-working area corresponding to the shapes of the working and non-working areas. The second data may include the pixel information of the working area corresponding to the shape of the working area, or the second data may include the pixel information of the working area and the non-working area corresponding to the shape of both the working and non-working areas. The storage device 122 can be a non-volatile memory (such as a ROM, a flash memory, etc.) to store information of the shape of the display panel 124, and the location information and extended display identification data (EDID) of the display panel 124 corresponding to a video frame. The extended display identification data at least includes various basic display parameters of the display panel 124, pixel clocks, a manufacturer name, and a serial number of the display panel 124, etc., which are usually stored on the storage device 122 of the display, and the transmitting end 110 can read the storage device 122 using software through a communication protocol such as an I²C bus. The shape of the display panel 124 can further be written into the extended display identification data. The timing controller 123 transmits scan line signals and data line signals in accordance with the second enable signal and the second data, so that the display panel 124 displays an image corresponding to the shape of the display panel 124.

The working area refers to the area to which the encoder actually transmits the enable signal and/or the data, and the non-working area refers to the other area to which the encoder does not transmit the enable signal and/or the data. The non-working area may contain traces, circuits, or pixels, but the pixels of the non-working area are not actually used for displaying an image. The working area corresponds to a shape of the display panel 124. In one embodiment, the video frame may refer to the same frame or different frames. For example, the enable signal and the data of the second frame can be transmitted when the first frame is displayed on the screen, as long as the time of transmission can be adjusted appropriately without departing from the spirit of the disclosure, and is not limited thereto. The electronic device can be, for example, a display, sensor device, an antenna, a spliced electronic device, a laptop, a desktop computer, etc. The display can be, for example, an OLED display, a QLED display, a LED display (including microLED and miniLED), flexible display, etc. If the electronic device is not for display, the working area refers to a range corresponding to the actual effective operation area, for example, the range in which electromagnetic waves or optical signals can be efficiently transmitted or received. Other non-effective operation areas correspond to the non-working areas. The timing controller 123 transmits a signal to enable an effective transmission or reception in the working area and/or the non-working area of the electronic device in accordance with the second enable signal and the second data.

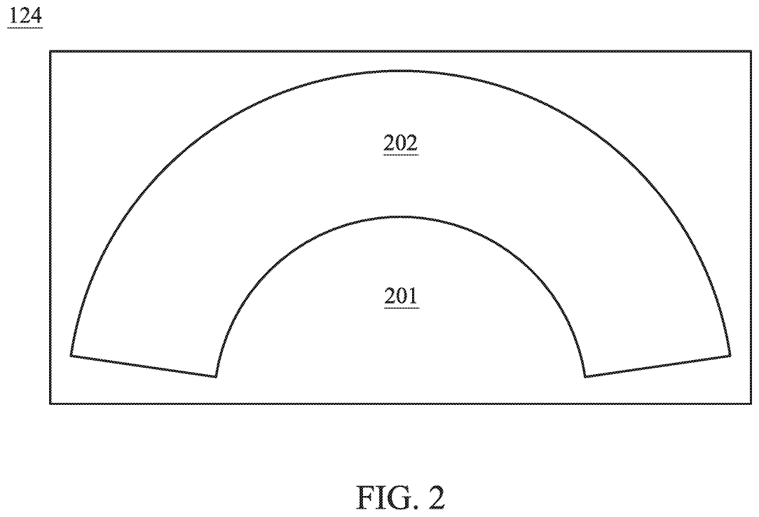

FIG. 2 is a schematic diagram of a video frame labeled with a working area and a non-working area in accordance with the embodiment of the disclosure. As shown in FIG. 2, when the shape of the working area of the display panel 124 is irregular, the image corresponding to a video frame includes a non-working area 201 and a working area 202. The non-working area 201 refers to a first portion other than the working area in the display panel 124, and the working area 202 is a second portion corresponding to the effective displayed image of the display panel 124. The shape of the working area 202 is the shape of a display region in the display panel 124, and the non-working area 201 is not used to display a valid displayed image. In the embodiment, when the transmitting end 110 connects to the receiving end 120, the encoder 111 first obtains a portion of the video frame corresponding to the working area 202. The encoder 111 can write information related to the shape of the working area 202 of the display panel 124 in advance in the corresponding code. Alternatively, in some embodiments of the disclosure, after being activated and communicating with the transmitting end 110 via a communication protocol, the receiving end 120 may also read out the information stored in the storage device 122 of the receiving end 120, and the information corresponds to the shape of the working area 202 of the display panel 124. The encoder 111 may receive the information corresponding to the shape of the working area 202 of the display panel 124 from the receiving end 120. Then, after receiving the information corresponding to the shape of the working area 202 of the display panel 124 from the encoder 111 of the transmitting end 110, the encoder 111 can convert the image information corresponding to the working area 202 to the first enable signal and the first data, and output the first enable signal and the first data to the decoder 121 of the receiving end 120. In other words, the first data includes the information about each pixel in the working area.

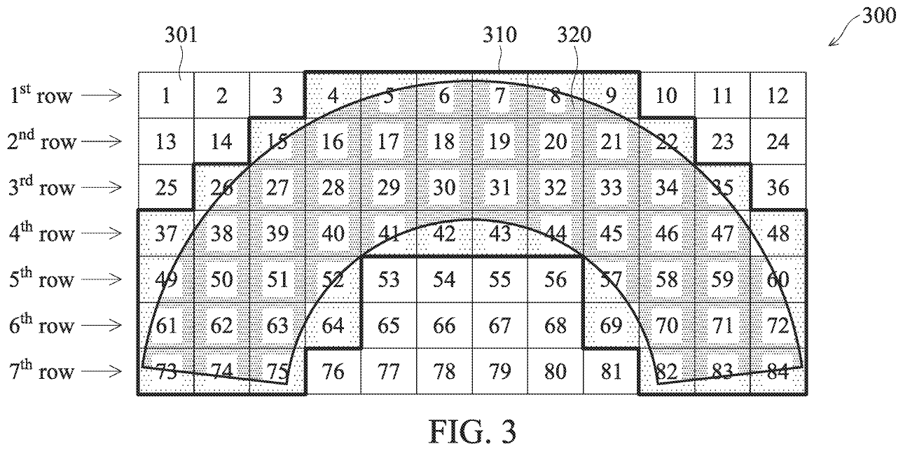

FIG. 3 is a schematic diagram of a video frame labeled with a working area and a non-working area in accordance with another embodiment of the disclosure. As shown in FIG. 3, the resolution of a video frame is 12*7: the number “1” shown in the square 301 represents the first pixel, and so on. Furthermore, an area 310 is the working area corresponding to the display panel 124, the area 320 is an area corresponding to the effective displayed image, and the area other than the area 310 is a non-working area. In the embodiment, after the encoder 111 obtains a video frame labeled with the working area and the non-working area in FIG. 3 by the method described above, the encoder 111 outputs the enable signal (the first enable signal) and the first data corresponding to the pixel information of the working area in units of “row” and “pixel”. For example, the first row of the video frame includes the 1^{st} to the 12^{th} pixels, and the pixels in the working area in the first row are the 4^{th} to 9^{th} pixels. Similarly, the second row of the video frame includes the 13^{th} to 24^{th} pixels, and the pixels in the working area in the second row are the 15^{th} to 22^{nd} pixels, and so on. However, since the working area is divided into two sections in the 5^{th} to 7^{th} rows (i.e. the pixels in the working area in the 5^{th} row are the 49^{th} to 52^{nd} pixels and the 57^{th} to 60^{th} pixels, the pixels in the working area in the 6^{th} row are the 61^{st} to 64^{th} pixels and the 69^{th} to 72^{nd} pixels, and the pixels in the working area in the 7^{th} row are the 73^{rd} to 75^{th} pixels and the 82^{nd} to 84^{th} pixels), when the encoder 111 outputs the enable signals corresponding to the 5^{th} to 7^{th} rows, the encoder 111 respectively outputs pulses corresponding to the two sections, thus when the decoder 121 receives the first enable signal and the first data output by the encoder 111, the decoder 121 knows that the two sections are to be decoded, and the corresponding first data is converted into the second enable signal and the second data for the actual display of the display panel. In this way, the decoder 121 can be prevented from substituting the pixel value into the wrong pixel value (for example, the pixel information of the 57^{th} pixel in the 5^{th} row is mistakenly transferred to be the pixel information of the 61^{st} pixel in the 6^{th} row). As described in the embodiment, by transmitting the enable signal and the data corresponding to the transmission working area, the present disclosure converts the second enable signal and the second data (the 1^{st} to 84^{th} pixels in FIG. 3) including 84 pixels that the encoder 111 needs to transmit to the decoder 121 to the first enable signal and the first data including 58 pixels (the 4^{th} to 9^{th}, 15^{th} to 22^{nd}, 26^{th} to 35^{th} to 52^{nd}, 57^{th} to 64^{th}, 69^{th} to 75^{th}, and 82^{nd} to 84^{th} pixels in FIG. 3): The number of pixel information transmissions is reduced by about 30%.

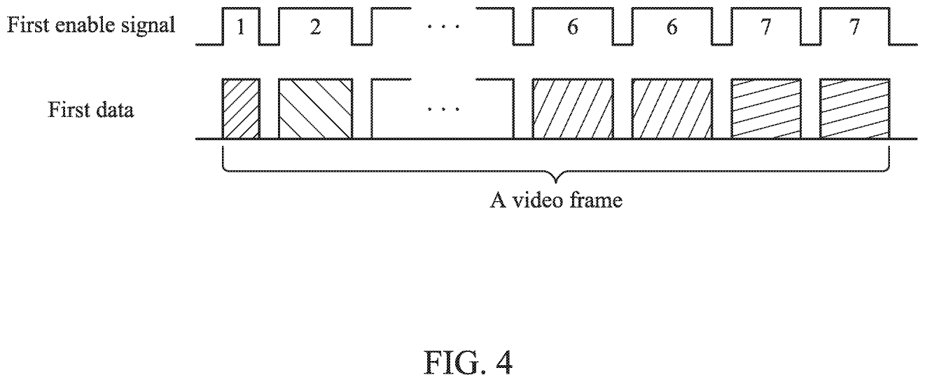

For example, FIG. 4 is a schematic diagram of a first enable signal corresponding to the working area in FIG. 3. As shown in FIG. 4, the pulse labeled “1” in the first enable signal indicates the effective display of the 1^{st} row, and the data corresponding to the effective display of the 1^{st} row are the pixel information contained in the effective displayed image. Namely, data corresponding to the first enable signal labeled “1” includes the pixel information corresponding to the 4^{th} to 9^{th} pixels in FIG. 3. Similarly, the pulse labeled “2” in the first enable signal indicates the effective display of the 2^{nd} row: Data corresponding to the first enable signal labeled “2” includes the pixel information corresponding to the 15^{th} to 22^{nd} pixels in FIG. 3. As mentioned above, since the working area is divided into two sections in the 5^{th} to 7^{th} rows, there are two pulses labeled “5” in the first enable signal, and the data corresponding to the two pulses labeled “5” respectively include the pixel information corresponding to the 49^{th} to 52^{nd} and the 57^{th} to 60^{th} pixels in the 5^{th} row. Similarly, the data correspond to the two pulses labeled “6” in the first enable signal include the pixel information corresponding to the 61^{st} to 64^{th} and 69^{th} to 72^{nd} pixels, and so on. In other words, the number of pixel information corresponding to the first enable signal and the first data output by the encoder 111 is smaller than that corresponding to the second enable signal and the second data decoded by the decoder 121. In other words, compared with the prior art, since the prior art has to transmit the pixel information of a complete video frame (including information of the working area and the non-working area), and the pixel information include the clock signal and the amount of data corresponding to the enable signal, the amount of data of the enable signal is necessarily greater than the amount of data corresponding to the effective displayed image. Thus, the amount of data corresponding to the first enable signal of the present disclosure (i.e. the first data) is smaller than that corresponding to the enable signal of the prior art (i.e. the second data). In other words, the data transmitted by the transmitting end 110 to the receiving end 120 can also be transmitted using a smaller transmission bandwidth.

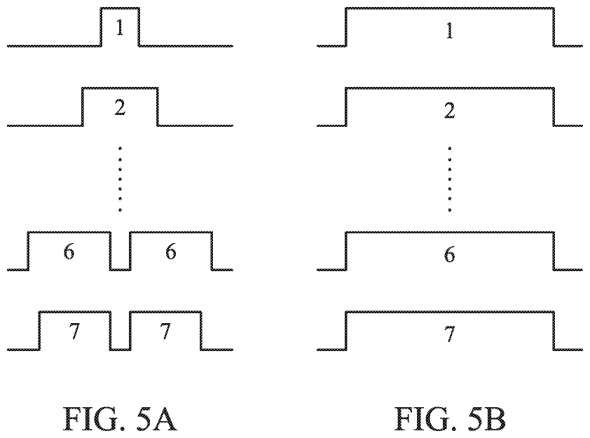

Then, after the decoder 121 in the receiving end 120 receives the first enable signal and the first data, since the first data only have the pixel information included in the effective displayed image in the working area, the location information corresponding to the working area is not included, the decoder 121 may generate the second enable signal and the second data corresponding to the complete video frame in accordance with the location data stored in the storage device 122, and the location data corresponds to the working area of the display panel 124 (i.e. the area 310 as shown in FIG. 3). For example, the decoder 121 can know, according to the information corresponding to the area 310 in FIG. 3, the pixel information included in the first data corresponding to the 1^{st} row (i.e. the label “1” in FIG. 4) is the pixel information corresponding to the 4^{th} to 9^{th} pixels in the 1^{st} row. The decoder 121 writes the pixel value in the first data into the 4^{th} to 9^{th} pixels. Furthermore, for the remaining pixels in the 1^{st} row (i.e. the 1^{st} to 3^{rd} pixels and the 10^{th} to 12^{th} pixels), since they are located in the non-working area, they are not displayed on the display panel 124, their pixel information can be substituted by an arbitrary value. For example, FIG. 5A is a schematic diagram of pulses corresponding to each of the rows of the first enable signal after encoding by the encoder 111 and FIG. 5B is a schematic diagram of pulses corresponding to each of the rows of the second enable signal after decoding by the decoder 121. The decoder 121 writes the pixel information corresponding to each row in the first data into the working area in accordance with the area 310 shown in FIG. 3 and replaces the pixel information of the pixels corresponding to the non-working area with the arbitrary value, and then the enable signal shown in FIG. 5A is converted into an enable signal (the second enable signal) and the second data corresponding to a complete video frame. Then, the decoder 121 outputs the second enable signal and the second data to the timing controller 123, so that the timing controller 123 may transmit scanning line signals and data line signals in accordance with the second enable signal and the second data to enable the display panel 124 to display an image on the screen corresponding to the video frame.

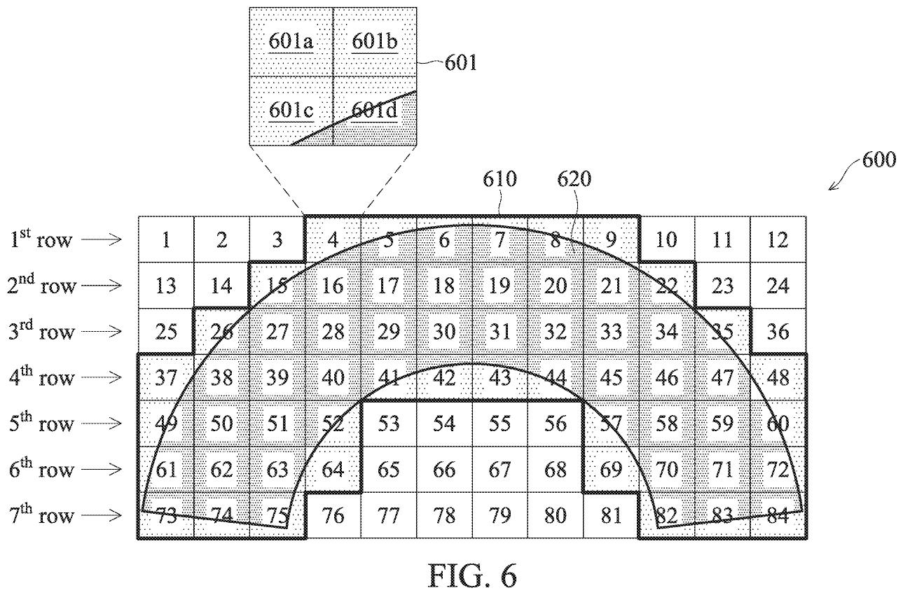

Furthermore, according to another embodiment, when the resolution of the display panel is high, the information corresponding to the shape of the working area of the display panel may occupy a large storage device space in the storage device 122. For example, when the resolution is 1920*1080, the required storage device space is about 2M bits. For another example, when the resolution is 3840*2160, the required storage device space is about 8M bits. In short, the greater the resolution is, the larger the storage device space is required. In order to resolve the problem of the storage device space, the encoder 111 may divide the displayed image into a plurality of sub-areas, each of the sub-areas includes a plurality of pixels, and output the first enable signal and the first data corresponding to the pixel information of the working area in units of “row” and “sub-area”. For example, as shown in FIG. 6, the encoder 111 divides the displayed image into sub-areas of 12*7, and each sub-area (the square 601 shown in FIG. 6) includes four pixels (that is. 601a to 601d). In other words, the number of sub-areas of video frame 600 is less than the number of pixels for the actual resolution (24*14). Furthermore, when only a portion of the pixels in the sub-area are located in the working area, other pixels of the sub-area are still output through the first enable signal. For example, as shown in the sib-area 601, the original effective displayed image of the working area only needs to display the pixel information corresponding to the pixels 601c and 601d without displaying the pixel information corresponding to the display pixels 601a and 601 b. Since the pixels 601a and 601b are located in the sub-area 601, the pixel information of the pixels 601a and 601b is also outputted through the first enable signal and the first data. Therefore, the pixels 601c and 601d correspond to the effective displayed image, and the pixels 601a and 601b correspond to the non-effective displayed image. Thus, a shielding layer can be selectively disposed to shield the pixels 601a and 601b, so that an observer cannot see the pixels 601a and 601b. Alternatively, black screen information or a gray scale signal of 0 may be selectively transmitted to the pixels 601a and 601b, so that the pixels 601a and 601b display a black screen. Similarly, the area 610 is a working area corresponds to the display panel 124, and the area other than the area 610 is a non-working area. When the encoder 111 generates the enable signal and the corresponding data, the pixel information corresponding to the sub-area located in the working area in the 1^{st} row is outputted to the receiving end 120 in units of “sub-area”. As described in the embodiment, the disclosure reduces the amount of data of the pixel information from original 336 (84*4=336) to 232 (58*4=232). The number of pixel information transmissions is reduced by about 30%. The dividing rule that the encoder 111 divides the displayed image into a plurality of sub-areas is stored in the storage device 122. After receiving the first enable signal and the first data, the decoder 121 restores the effective image on the screen in accordance with the dividing rule stored in the storage device 122 (as shown in the area 620).

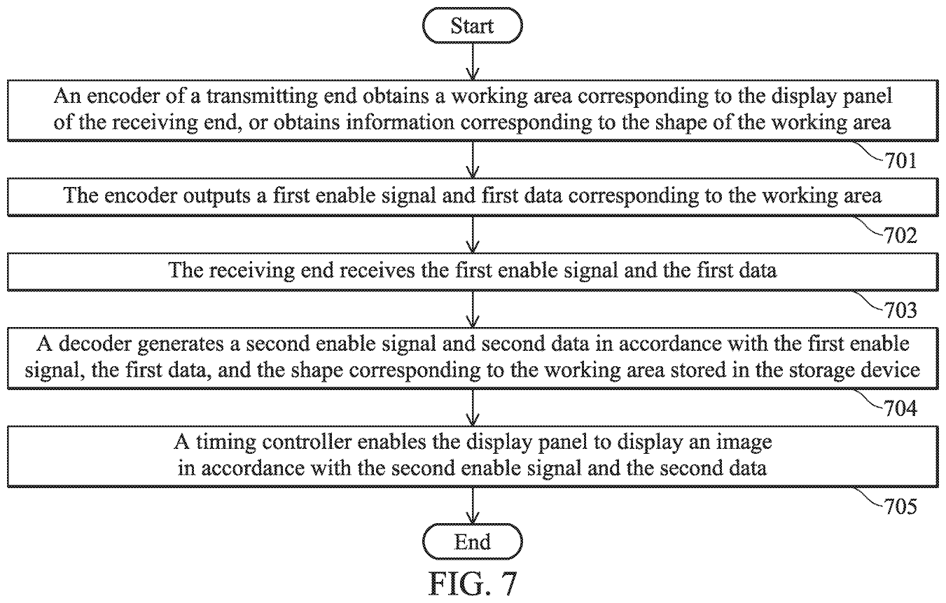

Referring to FIG. 1, FIG. 7 is a flow chart of a display system operation method in accordance with an embodiment of the disclosure. In step S701, the encoder 111 of the transmitting end 110 obtains a working area corresponding to the display panel 124 of the receiving end 120, or obtains information corresponding to the shape of the working area. In step S702, the encoder 111 outputs a first enable signal and first data including pixel information of the working area. In step S703, the decoder 121 of the receiving end 120 receives the first enable signal and the first data. After being activated and during the communication with the transmitting end 110, the receiving end 120 may also read out the information stored in the storage device 122 of the receiving end 120, and the information corresponds to the shape of the working area of the display panel 124. The encoder 111 may receive the information corresponding to the shape of the working area of the display panel 124 from the receiving end 120. In step S704, the decoder 121 generates a second enable signal and second data in accordance with the first enable signal, the first data, and the shape corresponding to the working area stored in the storage device 122. Finally, proceeding to step S705, the decoder 121 outputs the second enable signal and the second data to the timing controller 123. The timing controller 123 transmits a scan line signal and a data line signal in accordance with the second enable signal and the second data, so that the display panel 124 displays a displayed image. In addition, the encoder 111 divides the working area into a plurality of sub-areas with the same size, and generates the first enable signal and the first data based on the sub-areas. Each of the sub-areas includes a plurality of pixels. In an embodiment, the first enable signal and the first data can include at least two data corresponding to the same row.

It should be noted that the step S701 is an unnecessary step that can be omitted. For example, when the shape of one of the working areas is known, the encoder 111 can write the information related to the shape of the working area of the display panel 124 in advance into the corresponding code. Since the information of the working area is already present in the encoder 111, the display system operation method can start from the step S702.

In summary, according to the display system and the display system operation method in accordance with some embodiments of the disclosure, by transmitting only the image information corresponding to the working area of the display panel, the transmission bandwidth required for transmitting the displayed image can be effectively reduced to avoid unnecessary image information in the non-working area using up the transmission bandwidth, so as to improve the utilization of the bandwidth.

The ordinals in the specification and the claims of the present disclosure, such as “first”, “second”, “third”, etc., has no sequential relationship, and is just for distinguishing between two different devices with the same name. In the specification of the present disclosure, the word “couple” refers to any kind of direct or indirect electronic connection. The present disclosure is disclosed in the preferred embodiments as described above, however, the breadth and scope of the present disclosure should not be limited by any of the embodiments described above. Persons skilled in the art can make small changes and retouches without departing from the spirit and scope of the disclosure. The scope of the disclosure should be defined in accordance with the following claims and their equivalents.

What is claimed is:

1. A display system, comprising:
a transmitting end, comprising:
an encoder, outputting a first enable signal and first data corresponding to a working area of a display panel;
a receiving end, comprising:
a decoder, generating a second enable signal and second data in accordance with a shape of the working area, the first enable signal and the first data, wherein the second enable signal comprises pulse signals of the working area and a non-working area of the display panel; and
a timing controller, enabling the display panel to display an image in accordance with the second enable signal and the second data.

2. The display system as claimed in claim 1, wherein the shape of the working area is stored in a storage device of the receiving end.

3. The display system as claimed in claim 2, wherein the encoder further receives the shape of the working area from the storage device via a communication protocol after the receiving end is activated.

4. The display system as claimed in claim 3, wherein the communication protocol comprises an I²C bus.

5. The display system as claimed in claim 2, wherein the shape of the working area of the display panel is written into the extended display identification data (EDID).

6. The display system as claimed in claim 5, wherein the extended display identification data at least comprises various basic display parameters of the display panel, pixel clocks, a manufacturer name, and a serial number of the display panel.

7. The display system as claimed in claim 1, wherein the encoder further divides the working area into a plurality of sub-areas with the same size, and generates the first enable signal and the first data based on the plurality of sub-areas, wherein each of the sub-areas comprises a plurality of pixels.

8. The display system as claimed in claim 7, wherein the encoder outputs the first enable signal and the first data corresponding to a pixel information of the working area in units of a row of pixels and a sub-area in the display panel.

9. The display system as claimed in claim 1, wherein the first enable signal and the first data comprise at least two data corresponding to a same row of pixels in the display panel.

10. The display system as claimed in claim 1, wherein the decoder further writes pixel information corresponding to each row of the display panel in the first data into the working area, and replaces the pixel information corresponding to the non-working area with an arbitrary value.

11. The display system as claimed in claim 1, wherein the decoder further outputs the second enable signal and the second data to the timing controller, and the timing controller transmits scanning line signals and data line signals in accordance with the second enable signal and the second data to enable the display panel to display the image corresponding to a video frame.

12. A display system operation method, comprising:
outputting a first enable signal and first data corresponding to a working area of a display panel by a transmitting end of an encoder;
receiving the first enable signal and the first data by a receiving end of a decoder;
generating a second enable signal and second data in accordance with a shape of the working area, the first enable signal and the first data by the decoder, wherein the second enable signal comprises pulse signals of the working area and a non-working area of the display panel; and
enabling the display panel, by a timing controller, to display an image in accordance with the second enable signal and the second data.

13. The display system operation method as claimed in claim 12, further comprising:
receiving the shape of the working area, by the encoder, from a storage device of the receiving end via a communication protocol after the receiving end is activated.

14. The display system operation method as claimed in claim 13, wherein the communication protocol comprises an I²C bus.

15. The display system operation method as claimed in claim 12, further comprising:
writing the shape of the working area of the display panel into the extended display identification data.

16. The display system operation method as claimed in claim 12, further comprising:
dividing the working area, by the encoder, into a plurality of sub-areas of the same size; and
generating the first enable signal and the first data, by the encoder, based on the plurality of sub-areas;
wherein each of the sub-areas comprises a plurality of pixels.

17. The display system operation method as claimed in claim 16, further comprising:
outputting the first enable signal and the first data, by the encoder, corresponding to a pixel information of the working area in units of a row of pixels and a sub-area in the display panel.

18. The display system operation method as claimed in claim 12, wherein the first enable signal and the first data comprise at least two data corresponding to a same row of pixels in the display panel.

19. The display system operation method as claimed in claim 12, further comprising:
writing a pixel information, by the encoder, corresponding to each row of the display panel in the first data into the working area, and
replacing the pixel information, by the encoder, corresponding to the non-working area with an arbitrary value.

20. The display system operation method as claimed in claim 12, further comprising:
outputting the second enable signal and the second data, by the encoder, to the timing controller, and
transmitting scanning line signals and data line signals, by the timing controller, in accordance with the second enable signal and the second data to enable the display panel to display the image corresponding to a video frame.
